(19) United States
(12) Patent Application Publication
(10) Pub. No.: US 2023/0187703 A1
(43) Pub. Date: Jun. 15, 2023

(54) ELECTROLYTE FOR MANGANESE ION BATTERY AND MANGANESE ION BATTERY USING THE SAME

(71) Applicant: INDUSTRY ACADEMY COOPERATION FOUNDATION OF SEJONG UNIVERSITY, Seoul (KR)

(72) Inventors: Seung Taek MYUNG, Seoul (KR); Hee Jae KIM, Seoul (KR)

(73) Assignee: INDUSTRY ACADEMY COOPERATION FOUNDATION OF SEJONG UNIVERSITY, Seoul (KR)

(21) Appl. No.: 17/991,319

(22) Filed: Nov. 21, 2022

(30) Foreign Application Priority Data
Nov. 22, 2021 (KR) 10-2021-0161275

(51) Int. Cl. H01M 10/0569; H01M 10/054; H01M 10/0567; H01M 4/131; H01M 4/134

(52) U.S. Cl. CPC H01M 10/0569; H01M 10/054; H01M 10/0567; H01M 4/131; H01M 4/134; H01M 2300/0051; H01M 2004/027

(57) ABSTRACT

Provided are an electrolyte for a manganese ion battery and a manganese ion battery using the same. In the electrolyte for a manganese ion battery, manganese salt is dissolved in an organic solvent and dissociated into manganese ions and anions, and manganese ions are used as a charge transfer material in the electrolyte to enable charging and discharging of the manganese ion battery. The electrolyte for a manganese ion battery uses manganese ions as a charge transport material and thus has good compatibility with manganese metal used as a negative electrode. In addition, the manganese ion battery to which the electrolyte is applied can use manganese metal, which is significantly cheaper than lithium metal and has a lower reactivity than lithium metal, as a negative electrode, so there are fewer side reactions during battery operation.

### CROSS-REFERENCE TO RELATED APPLICATION

This application claims priority to and the benefit of Korean Patent Applications No. 2021-0161275, filed on Nov. 22, 2021, the disclosure of which is incorporated herein by reference in its entirety.

### BACKGROUND

### 1. Field of the Invention

The present invention relates to a secondary battery, and more particularly to a manganese ion battery.

### 2. Discussion of Related Art

In recent years, as portable wireless devices such as portable phones and portable computers have been made lighter and more functional, a lot of research has been conducted on secondary batteries used as driving power sources of them. Examples of the secondary batteries include a nickel cadmium battery, a nickel hydride battery, a nickel zinc battery, and a lithium secondary battery. Among them, lithium secondary batteries are widely used in the field of advanced electronic devices because they are rechargeable, have high operating voltage, and have high energy density per unit weight.

A lithium secondary battery uses a material capable of intercalating and deintercalating lithium ions as an anode and a cathode, and in particular, there is a trend to use lithium metal having a high theoretical capacity as an anode material. However, when lithium metal is used as an anode, as the charge and discharge cycles of the secondary battery are repeated, the lithium metal grows in the form of a dendrite. The dendrite may cause a short circuit of the battery in severe cases, resulting in the risk of explosion. Therefore, a new secondary battery with improved stability is required.

### SUMMARY OF THE INVENTION

The present invention is directed to provide an electrolyte for a manganese ion battery using manganese ions as a charge transport material and a manganese ion battery including the same.

In one aspect of the present invention, an electrolyte for a manganese ion battery is provided. The electrolyte comprises a manganese salt containing a manganese ion and an anion, and an organic solvent.

The manganese salt may include at least one selected from Mn(ClO₄)₂ and MnCl₂.

The organic solvent may include at least one selected from cyclic carbonates, linear ethers, and amides.

The cyclic carbonate may include at least one selected from ethylene carbonate, propylene carbonate, 1,2-butylene carbonate, and 2,3-butylene carbonate.

The linear ether may include at least one selected from dimethoxymethane, dimethoxyethane, diethoxyethane, 1,2-dimethoxypropane, and 1,3-dimethoxypropane.

The amide may include at least one selected from formamide, N-methyl formamide, N-ethyl formamide, N,N-dimethyl formamide, and N,N-diethyl formamide.

The concentration of the electrolyte may be 0.25 M to 5.0 M, specifically 1.0 M to 3.0 M.

An additive may be further included in the electrolyte.

The additive may include at least one selected from fluoroethylene carbonate (FEC) and 1,4 diazabicyclo[2,2,2]octane (DABCO).

In one aspect of the present invention, a manganese ion battery is provided. The manganese ion battery comprises a negative electrode containing manganese metal; a positive electrode containing a transition metal oxide or a transition metal hydroxide; and an electrolyte disposed between the negative electrode and the positive electrode and including a manganese salt and an organic solvent.

The transition metal oxide may be vanadium oxide, and the transition metal hydroxide may be vanadium hydroxide.

The vanadium oxide may be at least one selected from VO₂(B), V₂O₃, and V₂O₅.

According to the present invention described above, the electrolyte for a manganese ion battery of the present invention has good compatibility with manganese metal used as a negative electrode by using manganese ions as a charge transport material. In addition, the manganese ion battery to which the electrolyte for a manganese ion battery of the present invention is applied can use manganese metal as a negative electrode and the manganese metal is considerably cheaper than lithium metal and has lower reactivity than lithium metal, so there are fewer side reactions during battery operation.

### BRIEF DESCRIPTION OF THE DRAWINGS

The above and other objects, features, and advantages of the present invention will become more apparent to those of ordinary skill in the art by describing in detail exemplary embodiments thereof with reference to the adhered drawings, in which:

FIG. 1 is a schematic diagram showing the structure of a manganese ion battery according to an embodiment of the present invention;

FIG. 2 is a graph showing charge and discharge curves of a manganese ion battery according to Example 1 of the present invention;

FIG. 3 is a graph showing charge and discharge curves of a manganese ion battery according to Example 2 of the present invention;

FIG. 4 is a graph showing charge and discharge curves of a manganese ion battery according to Example 3 of the present invention;

FIG. 5 is a graph showing charge and discharge curves of a manganese ion battery according to Example 5 of the present invention;

FIG. 6 is a graph showing charge and discharge curves of a manganese ion battery according to Example 6 of the present invention;

FIG. 7 is a graph showing charge and discharge curves of a manganese ion battery according to Example 7 of the present invention;

FIG. 8 is a graph showing charge and discharge curves of a manganese ion battery according to Example 8 of the present invention;

FIG. 9 is a graph showing charge and discharge curves of a manganese ion battery according to Example 9 of the present invention; and

FIG. 10 is a graph showing charge and discharge curves of a manganese ion battery according to Example 10 of the present invention.

### DETAILED DESCRIPTION OF EXEMPLARY EMBODIMENTS

Since the present invention may have various changes and various forms, specific embodiments are illustrated in the drawings and described in detail in the description. However, it should be understood that this is not intended to limit the present invention to the specific disclosed form, and includes all modifications, equivalents, and substitutes included in the spirit and scope of the present invention. Like reference numerals have been used for like elements throughout the description of each figure.

Unless defined otherwise, all terms used herein, including technical or scientific terms, have the same meaning as commonly understood by one of ordinary skill in the art to which the present invention belongs. Terms such as those defined in commonly used dictionaries should be interpreted as having a meaning consistent with the meaning in the context of the related art, and unless explicitly defined in the present application, they should not be interpreted in an ideal or excessively formal meaning.

Hereinafter, with reference to the accompanying drawings, preferred embodiments of the present invention will be described in more detail.

Manganese Ion Battery

FIG. 1 is a schematic diagram showing the structure of a manganese ion battery according to an embodiment of the present invention.

Referring to FIG. 1, a manganese ion battery 100 includes a negative electrode 10 including at least one selected from manganese metal and manganese alloy, a positive electrode 20 including a transition metal oxide or a transition metal hydroxide, and an electrolyte 40 disposed between the positive electrode 20 and the negative electrode 10 and containing a manganese salt and an organic solvent.

The manganese ion battery 100 of the present invention may refer to a battery utilizing manganese ions as a charge transfer material.

At least one selected from manganese metal and manganese alloy may be used as the negative electrode 10 of the manganese ion battery 100.

Manganese exhibits a standard electrode potential of −1.185 V (vs. SHE) (Mn²⁺+2e⁻ →Mn), a theoretical mass specific capacity of 975 mAh/g, and a theoretical volumetric specific capacity of 7,083 mAh/cm², which is the second highest volumetric specific capacity after aluminum. Therefore, manganese metal can be used as a negative electrode material for batteries that require high capacity storage capacity in a limited volume. In addition, since the manganese metal is considerably cheaper than lithium metal, it can solve the problem of unstable supply of lithium metal, and since it has lower reactivity than lithium metal, it can be a relatively stable material.

The negative electrode 10 is a manganese metal in the form of a foil or flake, and may have a thickness of 100 μm to 1000 μm, specifically 200 μm to 500 μm, but is not limited thereto.

In addition, the negative electrode 10 may use a manganese alloy. The manganese alloy may be an alloy made of manganese and at least one metal selected from Al, Si, Fe, Li, Mg, Cu, Ge, Co, Cr, Ni, and Sn.

The negative electrode 10 may include a solid electrolyte interface (SEI) layer formed by a decomposition reaction of additives and/or organic solvents on its surface. When the decomposition reaction of the electrolyte occurs on the surface of the negative electrode 10, manganese metal may be oxidized to form manganese oxide. In order to prevent forming the manganese oxide, it may be important to form an SEI layer that plays a role in preventing oxidation of manganese metal. In order to form such an SEI layer, additives may be additionally included in the electrolyte. Specifically, the additive may be at least one selected from fluoroethylene carbonate (FEC) and 1,4 diazabicyclo[2,2,2]octane (DABCO), but is not limited thereto. As the additive, fluoroethylene carbonate (FEC) may serve to form an SEI layer, for example, a Mn—F-based SEI layer, and DABCO may prevent oxidation of manganese and act as a surfactant that facilitates plating/stripping manganese ions.

When fluoroethylene carbonate (FEC) is used as the additive, it may be added in an amount of 0.5 to 5 wt % based on the total mass of the electrolyte. In one embodiment, the fluoroethylene carbonate (FEC) additive may be added in an amount of 2 wt % based on the total mass of the electrolyte, but is not limited thereto. In addition, when 1,4 diazabicyclo[2,2,2]octane (DABCO) is used as the additive, it may be added in an amount of 1 to 500 ppmw based on the total mass of the electrolyte. In one embodiment, the 1,4 diazabicyclo[2,2,2]octane (DABCO) additive may be added in an amount of 200 ppmw based on the total mass of the electrolyte, but is not limited thereto.

The positive electrode 20 may be formed from a slurry containing an active material, a binder, and a conductive material applied on a current collector.

An active material of the positive electrode 20 may include a transition metal oxide or a transition metal hydroxide. Specifically, the transition metal oxide may include vanadium oxide. More specifically, the vanadium oxide may include at least one selected from VO₂(B), V₂O₃ and V₂O₅. In particular, since manganese ion (Mn²⁺), which is a divalent ion, is used as a charge carrier, it is preferable to use a vanadium-based cathode active material having a wide range of oxidation numbers from 2 to 5. In addition, since it has a large crystal lattice size, insertion and desorption of manganese cations (Mn²⁺) may be facilitated during charging and discharging of the battery. In one embodiment, the transition metal oxide may be VO₂ (B), but is not limited thereto.

Meanwhile, the transition metal hydroxide may include vanadium hydroxide. Specifically, the vanadium hydroxide may be VO_{1.75}(OH)_{0.5}, but is not limited thereto.

The active material may be a composite obtained by adding reduced graphene oxide (rGO) powder. Specifically, the composite may be a mixture of transition metal oxide powder and 1 wt % to 10 wt % of rGO powder based on the weight of the transition metal oxide powder. In one embodiment, the composite may be a mixture of transition metal oxide powder and 5 wt % of rGO powder based on the weight of the transition metal oxide powder, but is not limited thereto.

The conductive material may be used without limitation as long as it is generally usable in the art, such as artificial graphite, natural graphite, carbon black, acetylene black, ketjen black, denka black, thermal black, channel black, carbon nanofibers, carbon nanotubes, metal fibers, or mixtures thereof. In one embodiment, the conductive material may be a mixture of ketjen black and super P in a mass ratio of 1:1, but is not limited thereto.

The binder may be used without limitation as long as it is generally usable in the art, such as polyvinylidene fluoride (PVdF), polyhexafluoropropylene-polyvinylidene fluoride copolymer (PVdF/HFP), poly(vinyl acetate), polyvinyl alcohol, polyethylene oxide, polyvinylpyrrolidone, polyvinylpyridine, alkylated polyethylene oxide, polyvinyl ether, poly(methyl methacrylate), poly(ethyl acrylate), polytetrafluoroethylene (PTFE), polyvinyl chloride, polyacrylonitrile, styrene-butadiene rubber, acrylonitrile-butadiene rubber, fluoro rubber, ethylene-propylene-diene monomer (EPDM), sulfonated ethylene-propylene-diene monomer, carboxymethylcellulose (CMC), sodium carboxymethylcellulose, regenerated cellulose, starch, hydroxypropyl cellulose, tetrafluoroethylene, or a mixture thereof. In one embodiment, the binder may include sodium carboxymethyl cellulose, but is not limited thereto.

The solvent for forming the slurry containing the active material of the positive electrode 20, the binder, and the conductive material may include an aqueous solvent such as water, ethanol, isopropyl alcohol (IPA), or organic solvent such as N-methyl pyrrolidone (NMP), dimethyl formamide (DMF), acetone, and these solvents may be used alone or in combination of two or more. In one embodiment, the solvent may be water, but is not limited thereto. The amount of the solvent used may be adjusted so as to dissolve and disperse the active material, the binder, and the conductive material, and to have an appropriate viscosity of the slurry in consideration of the coating thickness and manufacturing yield.

The active material of the positive electrode 20, the binder, and the conductive material may be mixed in a certain ratio to form the slurry having appropriate viscosity and processability. The ratio of the active material, the binder, and the conductive material may be 8:1:1 in terms of mass ratio, but is not limited thereto.

The positive electrode 20 may be formed on a current collector layer to a thickness of 50 to 200 μm, specifically, to a thickness of 80 to 120 μm. In one embodiment, the positive electrode 20 may be formed on the current collector layer to a thickness of 100 μm, but is not limited thereto.

The separator 30 may be disposed between the negative electrode 10 and the positive electrode 20 to electrically insulate the electrodes. In addition, the separator 30 is sufficiently impregnated with the electrolyte 40, and the porous interior threreof may allow manganese ions to move from the negative electrode to the positive electrode and from the positive electrode to the negative electrode.

The separator 30 may be a conventional porous polymer film used as a separator, for example, polyolefin based porous polymer film including ethylene homopolymer, propylene homopolymer, ethylene/butene copolymer, ethylene/methacrylate copolymer, or polyvinyl alcohol, which may be used alone or in a laminated form. Alternatively, the separator 30 may be a conventional porous nonwoven fabric formed from, for example, glass fiber, carboxymethyl cellulose, polyethylene terephthalate fiber, etc. In one embodiment, the separator 30 may be a glass fiber membrane having a thickness of 10 to 500 μm, but is not limited thereto.

The negative electrode 10 and the positive electrode 30 may further include a current collector layer (not shown) on opposite sides in a direction facing each other. The current collector layer is not particularly limited as long as it has conductivity without causing chemical change to the battery, and may be a conductive material that can be easily adhered to the slurry of the active material and is non-reactive in the voltage range of the battery. As a non-limiting example of the current collector layer, carbon paper having a thickness of 3 to 500 μm may be used, but is not limited thereto.

The manganese ion battery including the electrolyte according to one embodiment of the present invention can be manufactured in any shape, such as a coin type, cylindrical shape, pouch type, etc., but is not limited to this shape.

Electrolyte for Manganese Ion Battery

Referring back to FIG. 1, the electrolyte 40 for a manganese ion battery according to an embodiment of the present invention may include a manganese salt containing manganese ions and anions and an organic solvent.

In the electrolyte 40, the manganese salt acts as a source of manganese ions and a charge transport material in the battery, enabling the manganese ion battery to operate. The manganese salt is a material in which a manganese cation (Mn²⁺) and an anion are bonded in the form of a salt, and can be dissolved in an organic solvent and dissociated into the manganese cation (Mn²⁺) and the anion. For example, the manganese salt may include at least one selected from Mn(ClO₄)₂ and MnCl₂.

The manganese salt may be used in a concentration of, for example, 0.25 M to 5.0 M, and specifically, 1.0 M to 3.0 M, in order to secure practical performance of the manganese ion battery. When the concentration of the manganese salt is within the above range, the electrolyte may have appropriate ionic conductivity and viscosity, so excellent electrolyte performance can be obtained, and manganese ions can move effectively in the electrolyte. When the concentration of the electrolyte containing the manganese salt exceeds 3.0 M, the manganese salt may not be dissolved in the organic solvent and a precipitate may be generated, which may not be suitable for use as an electrolyte solution. On the other hand, when the concentration of the electrolyte is less than 0.25 M, the amount of dissociated manganese ions in the electrolyte may be insufficient, and thus the charge/discharge characteristics of the manganese ion battery may be significantly deteriorated.

The organic solvent serves as a medium through which ions involved in the electrochemical reaction of the battery can move in the electrolyte for the manganese ion battery.

The organic solvent may include at least one selected from cyclic carbonates, linear ethers, and amides.

The cyclic carbonate may include at least one selected from ethylene carbonate, propylene carbonate, 1,2-butylene carbonate, and 2,3-butylene carbonate. In one embodiment, the cyclic carbonate may include propylene carbonate, but is not limited thereto.

The linear ether may include at least one selected from dimethoxymethane, dimethoxyethane, diethoxyethane, 1,2-dimethoxypropane, and 1,3-dimethoxypropane. In one embodiment, the linear ether may include dimethoxyethane, but is not limited thereto.

The amide may include at least one selected from formamide, N-methyl formamide, N-ethyl formamide, N,N-dimethyl formamide, and N,N-diethyl formamide. In one embodiment, the amide may include formamide or N-methyl formamide, but is not limited thereto.

The organic solvents may be used alone or in combination of two or more, and the mixing ratio when two or more organic solvents are used may be appropriately adjusted according to the desired battery performance.

An additive may be further included in the electrolyte for a manganese ion battery. The additive may include at least one selected from fluoroethylene carbonate (FEC) and 1,4 diazabicyclo[2,2,2]octane (DABCO). The fluoroethylene carbonate (FEC) and the DABCO may be decomposed during the charge/discharge cycle of the battery to form a polymer coating layer (or SEI layer) on the surface of the negative electrode and prevent oxidation of manganese metal used as the negative electrode.

Hereinafter, in order to explain the present invention in more detail, preferred experimental examples according to the present invention will be described in more detail with reference to the accompanying drawings. However, the present invention is not limited to the embodiments described herein and may be embodied in other forms.

### Preparation Example 1: Preparation of Positive Electrode

A solution in which a V₂O₅(vanadium pentoxide) was dispersed in ethanol was subjected to solvothermal synthesis at 150° C. for 12 hours. Thereafter, 500 ml of ethanol was used for filtration, reaction by-products were removed, and the remaining solid was dried at 80° C. for 12 hours to obtain VO₂(B) active material powder. Then, VO₂(B)/rGO composite powder was prepared by mixing the VO₂(B) powder and 5 wt % of rGO powder with respect to VO₂(B) powder.

After quantifying the VO₂(B)/rGO composite powder, the conductive material in which Ketjen black and super P were mixed in a mass ratio of 1:1, and the sodium carboxymethylcellulose binder in a mass ratio of 8:1:1, water was mixed to form a positive electrode slurry. Then, the positive electrode slurry was applied on a carbon paper current collector to a thickness of 100 μm using a doctor blade, and dried at 80° C. for 12 hours to prepare a positive electrode.

### Example 1: Preparation of Manganese Ion Battery Using Electrolyte Containing 0.25 M Mn(ClO₄)₂ and Propylene Carbonate

0.25 M of Mn(ClO₄)₂·xH₂O was weighed and dissolved in a propylene carbonate solvent, and stirred at 40° C. for 24 hours or more to prepare an electrolyte for a manganese ion battery.

The positive electrode prepared in Preparation Example 1, a glass-fiber separator, and a negative electrode using the manganese metal foil were sequentially laminated, and an R2032 coin type battery was assembled. Then, the prepared electrolyte was injected. All manufacturing processes were carried out inside the glove box.

### Example 2: Preparation of Manganese Ion Battery Using Electrolyte Containing 1.0 M Mn(ClO₄)₂ and Propylene Carbonate

A manganese ion battery was prepared in the same manner as in Example 1, except that the electrolyte was prepared using the manganese salt at a concentration of 1.0 M instead of 0.25 M.

### Example 3: Preparation of Manganese Ion Battery Using Electrolyte Containing 3.0 M Mn(ClO₄)₂ and Propylene Carbonate

A manganese ion battery was prepared in the same manner as in Example 1, except that the electrolyte was prepared using the manganese salt at a concentration of 3.0 M instead of 0.25 M.

### Example 4: Preparation of Manganese Ion Battery Using Electrolyte Containing 4.0 M Mn(ClO₄)₂ and Propylene Carbonate

A manganese ion battery was prepared in the same manner as in Example 1, except that the electrolyte was prepared using the manganese salt at a concentration of 4.0 M instead of 0.25 M.

### Example 5: Preparation of a Manganese Ion Battery Using FEC as an Electrolyte Additive

A manganese ion battery was manufactured in the same manner as in Example 3, except that 2 wt % of fluoroethylene carbonate (FEC) based on the total mass of the electrolyte was added to the electrolyte.

### Example 6: Preparation of a Manganese Ion Battery Using DABCO as an Electrolyte Additive

A manganese ion battery was manufactured in the same manner as in Example 3, except that 200 ppmw of 1,4 diazabicyclo[2,2,2]octane (DABCO) based on the total mass of the electrolyte was added to the electrolyte.

### Example 7: Preparation of a Manganese Ion Battery Using Dimethoxyethane as an Organic Solvent

A manganese ion battery was prepared in the same manner as in Example 2, except that the electrolyte was prepared using dimethoxyethane instead of propylene carbonate.

### Example 8: Preparation of a Manganese Ion Battery Using N-Methylformamide as an Organic Solvent

A manganese ion battery was prepared in the same manner as in Example 2, except that the electrolyte was prepared using N-methylformamide instead of propylene carbonate.

### Example 9: Preparation of a Manganese Ion Battery Using Formamide as an Organic Solvent

A manganese ion battery was prepared in the same manner as in Example 1, except that the electrolyte was prepared using formamide instead of propylene carbonate.

### Example 10: Preparation of Manganese Ion Battery Using MnCl₂ as Manganese Salt

A manganese ion battery was prepared in the same manner as in Example 9, except that the electrolyte was prepared using MnCl₂ (anhydrous) as a manganese salt instead of Mn(ClO₄)₂.

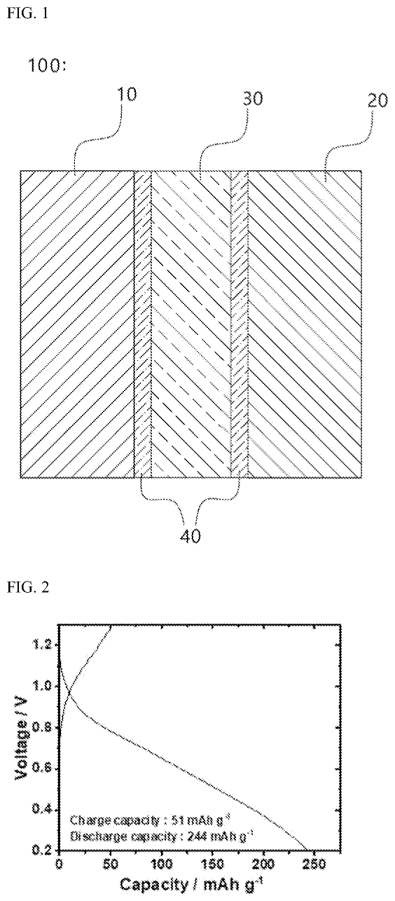

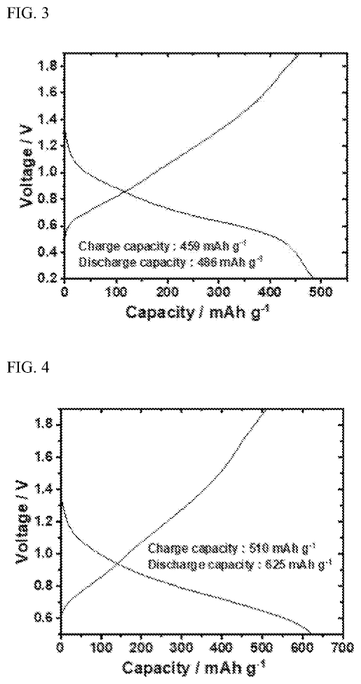

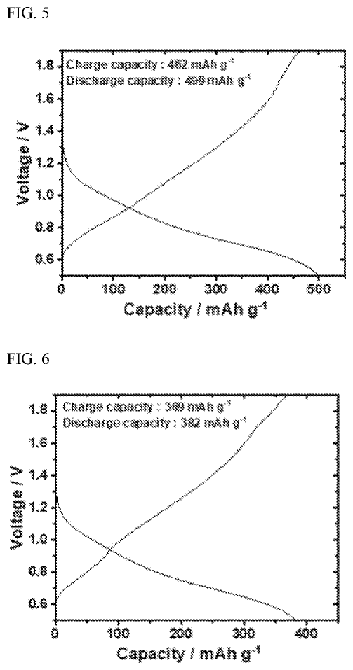

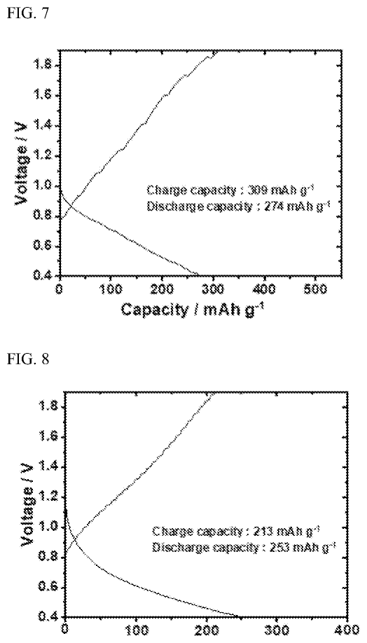

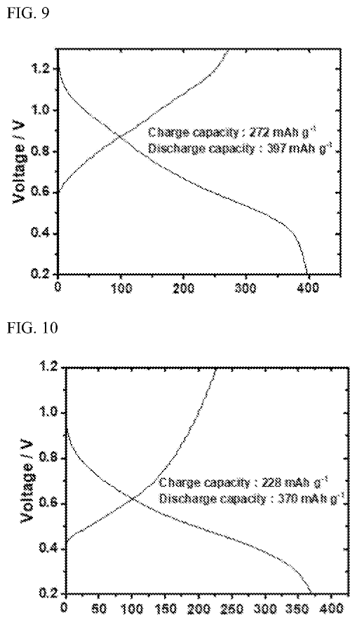

FIGS. 2 to 10 are graphs showing charge and discharge curves of manganese ion batteries according to Examples 1 to 3 and 5 to 10 of the present invention, respectively.

Referring to FIGS. 2 to 10, the charge and discharge capacity calculated through the charge and discharge graph of the manganese ion battery measured under the condition of current density of 50 mA/g is indicated, and the composition of the electrolyte used in the experiment is shown in Table 1 below.

TABLE 1

| | Manganese | | | | Charging | Discharging |
|---|---|---|---|---|---|---|
| | Salt Conc. | Manganese | | | Capacity | Capacity |
| | (M) | Salt | Organic Solvent | Additive | (mAh/g) | (mAh/g) |
| Example 1 | 0.25 | Mn(ClO₄)₂ | PC | — | 51 | 244 |
| Example 2 | 1.0 | Mn(ClO₄)₂ | PC | — | 459 | 486 |
| Example 3 | 3.0 | Mn(ClO₄)₂ | PC | — | 510 | 625 |
| Example 4 | 4.0 | Mn(ClO₄)₂ | PC | — | ND | ND |
| Example 5 | 3.0 | Mn(ClO₄)₂ | PC | FEC | 462 | 499 |
| | | | | 2 wt % | | |
| Example 6 | 3.0 | Mn(ClO₄)₂ | PC | DABCO | 369 | 382 |
| | | | | 200 ppm | | |
| Example 7 | 1.0 | Mn(ClO₄)₂ | dimethoxyethane | — | 309 | 274 |
| Example 8 | 1.0 | Mn(ClO₄)₂ | N-methyl | — | 213 | 253 |
| | | | formamide | | | |
| Example 9 | 0.25 | Mn(ClO₄)₂ | formamide | — | 272 | 397 |
| Example | 0.25 | MnCl₂ | formamide | — | 228 | 370 |
| 10 | | | | | | |

Table 1 is a table summarizing the composition of an electrolyte for a manganese ion battery and the charging and discharging capacity of a manganese ion battery using the electrolyte according to an embodiment of the present invention. In Table 1, the ND means that it cannot be measured or there is no measured value.

Referring to Table 1, in the cases of using Mn(ClO₄)₂ as the manganese salt according to Examples 1 to 4, the charge/discharge performance characteristics of the manganese ion battery according to the concentration of the manganese salt can be compared. It can be seen that as the concentration of manganese salt increases up to 3.0 M, the charge/discharge capacity of the battery simultaneously increases. However, as in the case of Example 4, when the concentration of the manganese salt exceeds 3.0 M, precipitates were generated during the preparation of the electrolyte solution, so it could not be used as an electrolyte, and therefore, it was impossible to manufacture a battery, so no measurement value was generated.

In addition, through the comparison of Example 3 and Examples 5 to 6, when Mn(ClO₄)₂ at a concentration of 3.0 M was used, the charge and discharge performance characteristics of the manganese ion battery according to the presence and type of additives could be compared. As additives, 2 wt % of fluoroethylene carbonate (FEC) and 200 ppm of 1,4 diazabicyclo[2,2,2]octane (DABCO) were used and compared with the case without additives. Since fluoroethylene carbonate (FEC) is widely used as an additive for lithium ion batteries, the addition of FEC is to examine its characteristics in manganese ion batteries. The addition of 1,4 diazabicyclo[2,2,2]octane (DABCO) was used for the purpose of preventing oxidation of manganese metal used as a negative electrode. As a result, in the case of Example 5 with the addition of FEC and Example 6 with the addition of DABCO, compared to Example 3 using the same concentration of manganese salt in the electrolyte, it was confirmed that the charge and discharge capacity was lowered and the improvement of the characteristics of the manganese ion battery was not confirmed.

Meanwhile, through comparison of Example 2 and Examples 7 to 8, when 1.0 M Mn(ClO₄)₂ was used as the manganese salt, the charge and discharge characteristics of the manganese ion battery according to the organic solvent dissolving the manganese salt could be compared. Propylene carbonate (PC) as a cyclic carbonate, dimethoxyethane (DME) as a linear ether, and N-methyl formamide (NMF) as an amide were used as organic solvents. This is to confirm the dissociation ability and solvent suitability of manganese electrolyte salts containing Mn²⁺ cations and ClO₄²⁻ anions under various organic solvent conditions. As a result, it was confirmed that the charge/discharge capacity of the manganese ion battery decreased in the order of propylene carbonate (PC), dimethoxyethane (DME), and N-methylformamide (NMF).

Meanwhile, through comparison of Example 1 and Example 9, when 0.25 M Mn(ClO₄)₂ was used as the manganese salt, the charge and discharge characteristics of the manganese ion battery according to organic solvent dissolving the manganese salt could be compared. As an organic solvent, propylene carbonate (PC) as a cyclic carbonate, and formamide as another amide were used. As a result, it was confirmed that the manganese ion battery using the formamide organic solvent of Example 9 had excellent charge and discharge capacity. This may mean that the formamide organic solvent dissociates manganese salt ions better than the cyclic carbonate organic solvent, resulting in high salt solubility and excellent ion conduction ability.

Through Example 9 and Example 10, it was possible to compare charge and discharge characteristics of manganese ion batteries according to manganese salt. Mn(ClO₄)₂ and MnCl₂ were used as the manganese salt, and formamide was used as the organic solvent. As a result of comparing the charging and discharging characteristics of the manganese ion batteries, it was confirmed that the case where Mn(ClO₄)₂ was used as the manganese salt in the formamide solvent had better charge and discharge capacity than MnCl₂. It can be seen that the dissociation ability of the manganese salt is superior as the radius of the ClO₄²⁻ anion (0.25 nm) is larger than that of the Cl⁻ anion (0.18 nm) and the tendency of charge delocalization is large. When MnCl₂ was used as the manganese salt, it was difficult to prepare an electrolyte having a concentration of more than 1.0 M; however, when Mn(ClO₄)₂ was used as the manganese salt, it was possible to prepare a higher molar electrolyte.

The embodiments of the present invention disclosed in this specification and drawings are only presented as specific examples to aid understanding, and are not intended to limit the scope of the present invention. In addition to the embodiments disclosed herein, it is obvious to those skilled in the art that other modified examples based on the technical idea of the present invention can be implemented.

### DESCRIPTION OF REFERENCE NUMBER

100: manganese ion battery, 10: negative electrode, 20: positive electrode, 30: separator, 40: electrolyte

1. An electrolyte for a manganese ion battery, comprising:
a manganese salt containing a manganese ion and an anion; and
an organic solvent.

2. The electrolyte for a manganese ion battery according to claim 1, wherein the manganese salt includes at least one selected from Mn(ClO₄)₂ and MnCl₂.

3. The electrolyte for a manganese ion battery according to claim 1, wherein the organic solvent includes at least one selected from cyclic carbonates, linear ethers, and amides.

4. The electrolyte for a manganese ion battery according to claim 3, wherein the cyclic carbonate includes at least one selected from ethylene carbonate, propylene carbonate, 1,2-butylene carbonate, and 2,3-butylene carbonate.

5. The electrolyte for a manganese ion battery according to claim 3, wherein the linear ether includes at least one selected from dimethoxymethane, dimethoxyethane, diethoxyethane, 1,2-dimethoxypropane, and 1,3-dimethoxypropane.

6. The electrolyte for a manganese ion battery according to claim 3, wherein the amide includes at least one selected from formamide, N-methyl formamide, N-ethyl formamide, N,N-dimethyl formamide, and N,N-diethyl formamide.

7. The electrolyte for a manganese ion battery according to claim 1, wherein the concentration of the electrolyte is 0.25 M to 5.0 M.

8. The electrolyte for a manganese ion battery according to claim 1, wherein the concentration of the electrolyte is 1.0 M to 3.0 M.

9. The electrolyte for a manganese ion battery according to claim 1, further comprising an additive.

10. The electrolyte for a manganese ion battery according to claim 9, the additive includes at least one selected from fluoroethylene carbonate (FEC) and 1,4 diazabicyclo[2,2,2]octane (DABCO).

11. A manganese ion battery comprising:
a negative electrode containing at least one selected from manganese metal and manganese alloy;
a positive electrode containing a transition metal oxide or a transition metal hydroxide; and
an electrolyte of claim 1 disposed between the negative electrode and the positive electrode.

12. The manganese ion battery according to claim 11, wherein the transition metal oxide is vanadium oxide.

13. The manganese ion battery according to claim 12, wherein the vanadium oxide is at least one selected from VO₂(B), V₂O₃, and V₂O₅.

14. The manganese ion battery according to claim 11, wherein the transition metal hydroxide is vanadium hydroxide.

15. The manganese ion battery according to claim 14, wherein the vanadium hydroxide is VO_{1.75} (OH)_{0.5}.
